(19) United States
(12) Patent Application Publication
(10) Pub. No.: US 2026/0056437 A1
(43) Pub. Date: Feb. 26, 2026

(54) DISPLAY DEVICE

(71) Applicant: Japan Display Inc., Tokyo (JP)

(72) Inventors: Akihiko SAITOH, Tokyo (JP); Hiroyuki ABE, Tokyo (JP)

(73) Assignee: Japan Display Inc., Tokyo (JP)

(21) Appl. No.: 19/262,198

(22) Filed: Jul. 8, 2025

(30) Foreign Application Priority Data
Aug. 26, 2024 (JP) 2024-144120

(51) Int. Cl. G02F 1/1368; G02F 1/1362

(52) U.S. Cl. CPC G02F 1/13685; G02F 1/136286

(57) ABSTRACT

A display device includes a substrate, at least one pixel over the substrate, at least one pad over the substrate, and a lead wiring. The at least one pad is configured to be electrically connected to a semiconductor element provided over a semiconductor substrate. The lead wiring electrically connects the at least one pixel to the at least one pad. The at least one pixel includes a transistor, a leveling film over the transistor, and a display element located over the leveling film and electrically connected to the transistor. The semiconductor element includes a circuit configured to drive the at least one pixel, a bump electrically connected to the circuit, and a dummy bump electrically independent from the circuit. The lead wiring is arranged to overlap the dummy bump through the leveling film when the bump is connected to the at least one pad.

### CROSS-REFERENCE TO RELATED APPLICATIONS

This application claims the benefit of priority to Japanese Patent Application No. 2024-144120, filed on Aug. 26, 2024, the entire contents of which are incorporated herein by reference.

### FIELD

An embodiment of the present invention relates to a display device.

### BACKGROUND

With increasing size and resolution of display devices, driver circuits for driving display devices are also required to realize high-speed operation. For this reason, a semiconductor element having integrated circuits fabricated over a semiconductor substrate is mounted as a part of driver circuits (e.g., all or part of the signal-line driver circuit) in some display devices (see, for example, Japanese Laid-Open Patent Publication No. 2023-184061).

### SUMMARY

An embodiment of the present invention is a display device. The display device includes a substrate, at least one pixel over the substrate, at least one pad over the substrate, and a lead wiring. The at least one pad is configured to be electrically connected to a semiconductor element provided over a semiconductor substrate. The lead wiring electrically connects the at least one pixel to the at least one pad. The at least one pixel includes a transistor, a leveling film over the transistor, and a display element located over the leveling film and electrically connected to the transistor. The semiconductor element includes a circuit configured to drive the at least one pixel, a bump electrically connected to the circuit, and a dummy bump electrically independent from the circuit. The lead wiring is arranged to overlap the dummy bump through the leveling film when the bump is connected to the at least one pad.

An embodiment of the present invention is a display device. The display device includes a substrate, at least one pixel over the substrate, at least one pad over the substrate, a lead wiring, and a semiconductor element. The lead wiring connects the at least one pixel to the at least one pad. The semiconductor element is electrically connected to the at least one pad and is provided over a semiconductor substrate. The at least one pixel includes a transistor, a leveling film, and a display element located over the leveling film and electrically connected to the transistor. The semiconductor element includes a circuit configured to drive the at least one pixel, a bump electrically connected to the circuit, and a dummy bump electrically independent from the circuit. The lead wiring overlaps the dummy bump through the leveling film.

### BRIEF DESCRIPTION OF DRAWINGS

FIG. 1 is a schematic top view of a display device according to an embodiment of the present invention.

FIG. 2 is a schematic top view of a display device according to an embodiment of the present invention.

FIG. 3 is a schematic cross-sectional view of a display device according to an embodiment of the present invention.

FIG. 4 is an equivalent circuit of a pixel of a display device according to an embodiment of the present invention.

FIG. 5 is a schematic cross-sectional view of a display device according to an embodiment of the present invention.

FIG. 6 is a schematic bottom view of a semiconductor element mounted in a display device according to an embodiment of the present invention.

FIG. 7 is a schematic top view of a display device according to an embodiment of the present invention.

FIG. 8 is a schematic top view of a display device according to an embodiment of the present invention.

FIG. 9 is a schematic top view of a display device according to an embodiment of the present invention.

FIG. 10 is a schematic cross-sectional view of a display device according to an embodiment of the present invention.

FIG. 11 is a schematic cross-sectional view of a display device according to an embodiment of the present invention.

FIG. 12 is a schematic cross-sectional view of a display device according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate. The reference number is used when plural structures which are the same as or similar to each other are collectively represented, while a hyphen and a natural number are further used when these structures are independently represented.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the embodiments of the present invention, when a plurality of films is formed with the same process at the same time, these films have the same layer structure, the same material, and the same composition. However, these films originate from a film formed by the same process as one film and have the same layer structure, the same material, and the same morphology. Hence, these films are defined as existing in the same layer.

In the specification and the claims, an expression “a structure is exposed from another structure” means a mode in which a part of the structure is not covered by the other structure and includes a mode where the part uncovered by the other structure is further covered by another structure. In addition, a mode expressed by this expression includes a mode where a structure is not in contact with other structures.

### 1. Overall Structure of Display Device

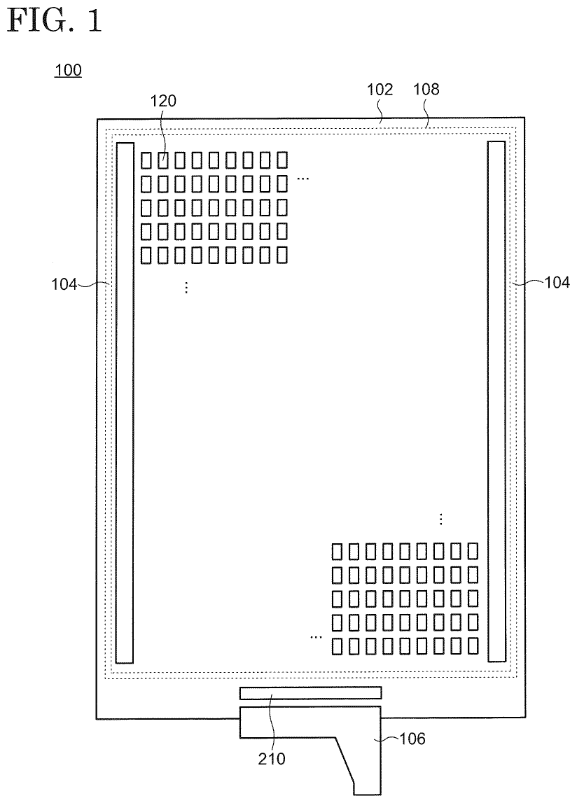

FIG. 1 shows a schematic top view of a display device 100 according to an embodiment of the present invention. The display device 100 depicted in FIG. 1 is a liquid crystal display device and has a substrate 102 and a counter substrate (not illustrated in FIG. 1) facing the substrate 102. A variety of patterned conductive films, semiconductor films, insulating films, and the like formed using photolithography processes is arranged between the substrate 102 and the counter substrate. These conductive films, semiconductor films, insulating films, and the like are combined as appropriate to form a plurality of pixels 120 each including a display element as well as a gate-line driver circuit 104 for driving the pixels 120. The plurality of pixels 120 and the region between adjacent pixels 120 are collectively called a display region, while a region surrounding the display region is called a frame region. The gate-line driver circuit 104 is provided in the frame region. On the frame region, a semiconductor element 210 having a circuit (integrated circuit) fabricated over a semiconductor substrate is further mounted as a signal-line driver circuit. A flexible printed circuit board (hereinafter, referred to as FPC) 106 is electrically connected to the display device 100, and power supply and a variety of control signals for displaying images are input to the semiconductor element 210 and the gate-line driver circuit 104 from an external circuit (not illustrated) via the FPC. The semiconductor element 210 and the gate-line driver circuit 104 generate a variety of signals to control the pixels 120 on the basis of these control signals and supply them to the pixels 120. As a result, the pixels 120 are controlled and images can be reproduced on the display region. Although not illustrated in FIG. 1, signal lines for supplying image signals, initialization signals, and the like to the pixels 120 and gate lines for supplying gate signals to the pixels 120 as well as pads for mounting the semiconductor element 210 and terminals for electrical connection of the FPC 106 are formed over the substrate 102 using a variety of patterned conductive films.

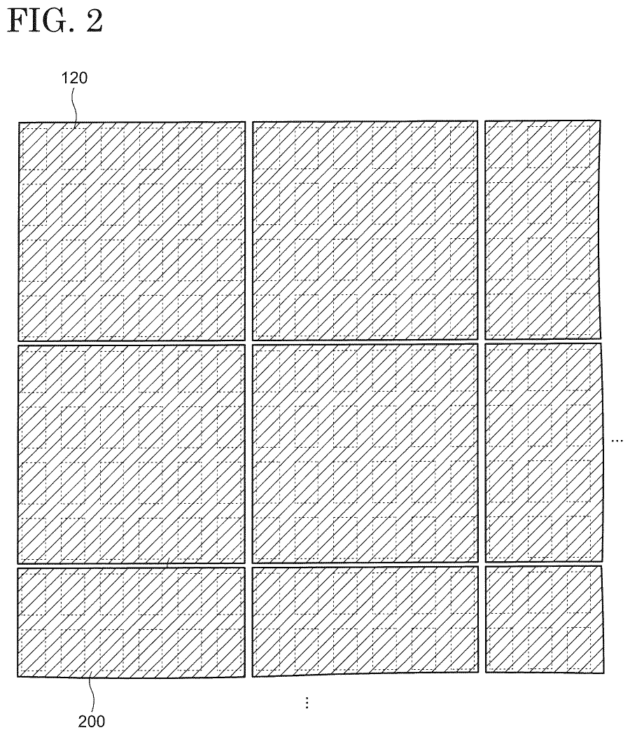

As an optional component, the display device 100 may have a function as a touch panel. In this case, a plurality of detection electrodes 200 arranged in a matrix form with a plurality of rows and a plurality of columns is arranged over the display region as shown in FIG. 2. The plurality of detection electrodes 200 is electrically connected to each other in the row direction and the column direction, and each detection electrode 200 is arranged to overlap the multiple pixels 120. A detection wiring which is not illustrated in FIG. 2 is electrically connected to each detection electrode 200, by which each detection electrode 200 is electrically connected to the semiconductor element 210 via the detection wiring. A pulsed AC potential is supplied from the semiconductor element 210 to the detection electrode 200 via the detection wiring, and the potential fluctuation of the detection electrodes 200 due to capacitive coupling caused by contact or proximity of an input means such as a finger or a touch pen is detected by the semiconductor element 210. As a result, the coordinates of the input means can be identified over the display device 100. Note that the detection electrode 200 also functions as a common electrode of the display elements provided in the display device 100 as described below.

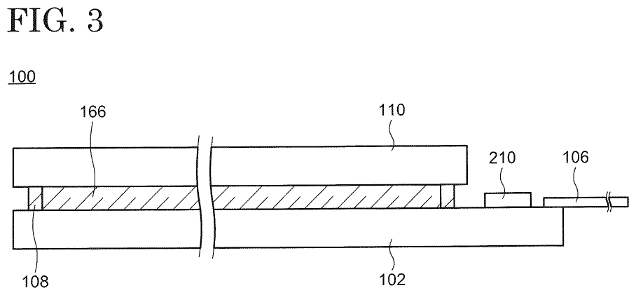

As shown in FIG. 1 and FIG. 3, the substrate 102 and the counter substrate 110 are secured to each other by a sealing material 108. The sealing material 108 is formed to surround the display region, and a liquid crystal layer 166 is injected into the space formed by the substrate 102, the counter substrate 110, and the sealing material 108. The FPC 106 and the semiconductor element 210 are fixed over the substrate 102 and are exposed from the counter substrate 110.

### 2. Structure of Pixel

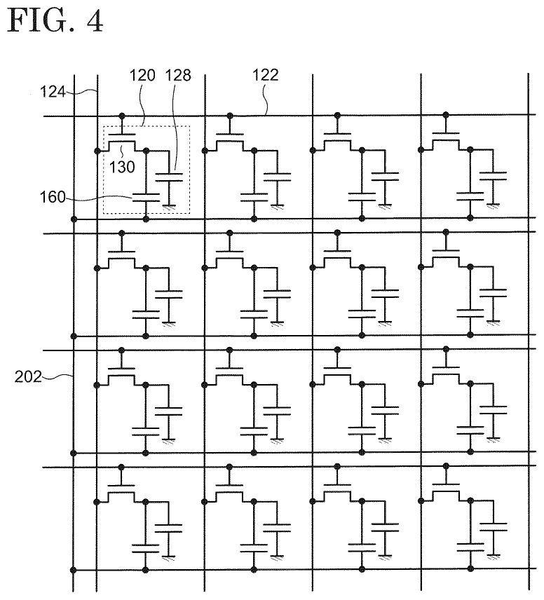

An equivalent circuit diagram of the pixel 120 is shown in FIG. 4. Here, an equivalent circuit of the pixels 120 arranged in a matrix of four rows and four columns is demonstrated. In the example shown in FIG. 4, a transistor (hereinafter, referred to as a switching transistor) 130, a capacitor element 128, and a display element 160 are arranged in each pixel 120. A gate of the switching transistor 130 is connected to a gate line 122 extending from the gate-line driver circuit 104. One terminal of the switching transistor 130 is electrically connected to a signal line 124 extending from the semiconductor element 210 side, while the other terminal is connected to one electrode of the capacitor element 128 and a pixel electrode of the display element 160. A constant potential is supplied to the other electrode of the capacitor element 128. As mentioned above, the detection electrode 200 functions as a common electrode of the display element 160. Therefore, the common electrode of the display element 160 (i.e., the detection electrode 200) is electrically connected to the detection wiring 202. A constant potential is applied to the detection electrode 200 via the detection wiring 202 during the display period of each pixel 120, and the gradation of the display element 160 is controlled by the potential difference between the pixel electrode 162 and the detection electrode 200. On the other hand, a pulsed AC potential is supplied to the detection electrode 200 during the detection period and is used to identify the coordinates of the input means. Note that the circuit structure of each pixel 120 is not limited to the structure shown in FIG. 4, and each pixel 120 may be structured by appropriately combining one or a plurality of transistors and one or a plurality of capacitor elements in addition to the display element 160.

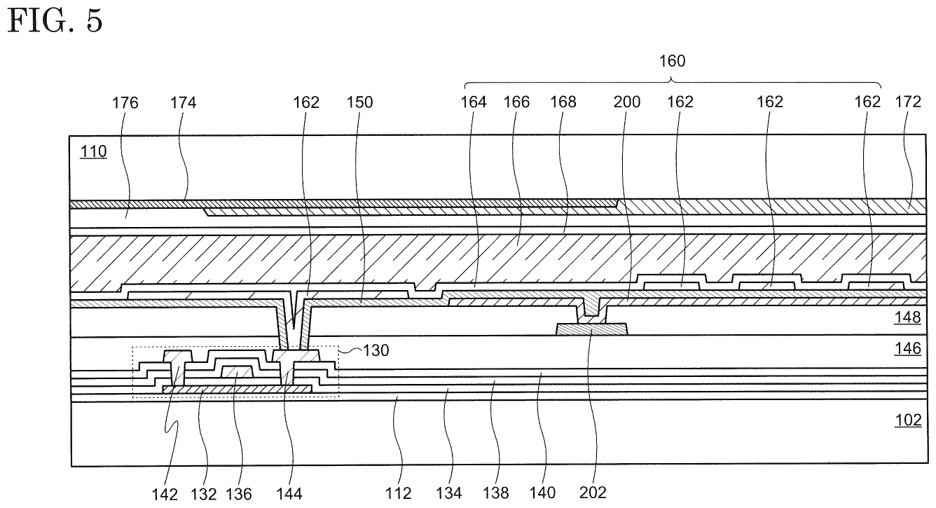

A schematic cross-sectional view of the display device 100 including one pixel is shown in FIG. 5. As shown in FIG. 5, the switching transistor 130 is provided over the substrate 102 either directly or through an undercoat 112 which is an optional component. There are no restrictions on the configuration of the switching transistor 130, and the switching transistor 130 may be a bottom-gate transistor, a top-gate transistor, or a transistor with a pair of gate electrodes vertically sandwiching a channel. In the example shown in FIG. 5, the switching transistor 130 is a top-gate type transistor and includes a semiconductor film 132, a gate insulating film 134 over the semiconductor film 132, a gate electrode 136 overlapping the semiconductor film 132 through the gate insulating film 134, one or a plurality of interlayer insulating films covering the gate electrode 136 (here, a first interlayer insulating film 138 and a second interlayer insulating film 140), a source electrode 142 and a drain electrode 144 electrically connected to the semiconductor film 132 through openings in the interlayer insulating films, and the like.

Two leveling films (a first leveling film 146 and a second leveling film 148) are provided over the switching transistor 130. The first leveling film 146 absorbs unevenness caused by the switching transistor 130, the capacitor element 128, and the like to form a flat top surface. The detection wiring 202 for supplying a potential to the detection electrode 200 extends over the first leveling film 146 from the semiconductor element 210 side, and the second leveling film 148 is formed to cover the detection wiring 202. The detection electrode 200 is formed over the second leveling film 148. Electrical connection between the detection electrode 200 and the detection wiring 202 is performed through an opening formed in the second leveling film 148.

The display element 160 demonstrated in FIG. 5 is an IPS (In-Plain Switching) liquid crystal element, and the pixel electrode 162 is arranged in a comb-like shape or with one or a plurality of openings or slits. Hence, although the pixel electrode 162 is depicted in FIG. 5 as being divided into multiple pieces, they are physically and electrically connected to form a single pixel electrode 162 within each pixel 120. The pixel electrode 162 is electrically connected to the drain electrode 144 of the switching transistor 130 through an opening formed in the first leveling film 146 and the second leveling film 148. Note that an interelectrode insulating film 150 is formed over the detection electrode 200 which also functions as the common electrode, thereby prohibiting electrical conduction between the detection electrode 200 and the pixel electrode 162. A first orientation film 164, a liquid crystal layer 166, and a second orientation film 168 are sequentially provided over the pixel electrode 162 and the detection electrode 200, and the liquid crystal element 160 is structured by the pixel electrode 162, the detection electrode 200, the first orientation film 164, the liquid crystal layer 166, and the second orientation film 168.

A light-shielding film 174 is provided to cover the switching transistor 130 and the detection wiring 202 over the counter substrate 110 (below the counter substrate 110 in FIG. 5). Although not illustrated in FIG. 5, the light-shielding film 174 is provided to further overlap the gate line 122, the signal line 124, and the like. On the other hand, a color filter 172 for providing color information is disposed in the region overlapping the pixel electrode 162 and the detection electrode 200, allowing each pixel 120 to function as the smallest unit providing color information. An overcoat 176 is formed to cover the color filter 172 and the light-shielding film 174. Although not illustrated, a spacer may further be provided in the liquid crystal layer 166 to maintain the thickness of the liquid crystal layer 166.

The components described above can be formed, for example, using the materials described below. The substrate 102 and the counter substrate 110 are configured to include glass, quartz, or a polymer such as a polyimide and a polycarbonate transmitting visible light. The substrate 102 and/or the counter substrate 110 may be flexible. The size and shape of the substrate 102 and the counter substrate 110 may be appropriately selected according to the application of the display device 100. The semiconductor film 132 is composed of a Group 14 element such as silicon or an oxide semiconductor such as an indium-gallium oxide and an indium-gallium-zinc oxide. There is no restriction on the crystallinity of the semiconductor film 132, and the semiconductor film 132 may be amorphous or polycrystalline. Each of the undercoat 112, the gate insulating film 134, the interlayer insulating film (first interlayer insulating film 138 and the second interlayer insulating film 140), the interelectrode insulating film 150, and the overcoat 176 is an inorganic film containing an inorganic compound and may be composed of one or a plurality of films containing a silicon-containing inorganic compound such as silicon oxide and silicon nitride. The first leveling film 146 and the second leveling film 148 include a polymer such as an epoxy resin, an acrylic resin, a silicon resin, and a polyimide resin. The gate electrode 136 may be formed with one or a plurality of layers including a metal with a relatively high melting point such as molybdenum, tantalum, tungsten, and chromium or an alloy including at least one metal selected from these metals. The source electrode 142, the drain electrode 144, and the detection wiring 202 may be composed of one or a plurality of layers including, in addition to the aforementioned metals, a highly conductive metal such as aluminum and copper or an alloy including at least one metal selected from these metals. The detection electrode 200 and the pixel electrode 162 may be composed of a conductive oxide transmitting at least a portion of visible light, such as indium-tin oxide and indium-zinc oxide. The first orientation film 164 and the second orientation film 168 may be composed of a polymer such as a polyimide.

### 3. Semiconductor Element

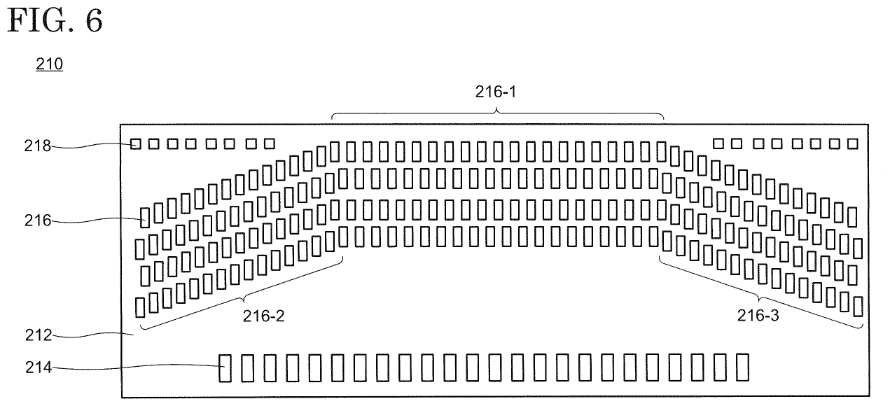

A schematic bottom view of the semiconductor element 210 is shown in FIG. 6. As shown in FIG. 6, a plurality of bumps is formed on a bottom surface of a main body 212 including the semiconductor substrate and the circuit. Specifically, the semiconductor element 210 has a plurality of output bumps 216 for outputting a variety of signals generated in the semiconductor element 210 and inputting them to the pixels 120 and the gate-line driver circuit 104 as well as a plurality of input bumps 214 for inputting the signals input via the FPC 106 to the circuit. The plurality of input bumps 214 and the plurality of output bumps 216 are electrically connected to the circuit in the main body 212.

As can be understood from FIG. 6, the plurality of input bumps 214 is arranged in a single row in the longitudinal direction of the semiconductor element 210. In contrast, the plurality of output bumps 216 is arranged over a plurality of rows in a staggered arrangement. In addition, the plurality of output bumps 216 can be divided into three bump groups each containing two or more output bumps 216.

In one bump group (first bump group) 216-1, the plurality of output bumps 216 is arranged in a plurality of rows (here, four rows) parallel to the arrangement direction of the plurality of input bumps 214 (i.e., the longitudinal direction of semiconductor element 210) and takes a staggered arrangement. On the other hand, although the plurality of output bumps 216 included in the second bump group 216-2 which is one of the other bump groups is also arranged over a plurality of rows and takes a staggered arrangement, the direction of each row is inclined from the arrangement direction of the plurality of input bumps 214. Similarly, although the plurality of output bumps 216 in the third bump group 216-3 which is the one remaining bump group is also arranged over a plurality of rows and take a staggered arrangement, the direction of each row is inclined from the arrangement direction of the plurality of input bumps 214. The first bump group 216-1 is located between the second bump group 216-2 and the third bump group 216-3. The plurality of output bumps 216 included in the second bump group 216-2 and the third bump group 216-3 is symmetrically positioned with respect to the first bump group 216-1 and is arranged such that the distance to the input bumps 214 decreases with increasing distance from the first bump group 216-1. As described below, such an arrangement allows for effective use of the frame region. That is, lead wirings connected to the output bumps 216 and used to supply a variety of signals to the pixels 120 can be arranged efficiently, and short circuits or current leakage between the lead wirings can be prevented. As a result, a display device with a narrow frame region and excellent design can be produced in a high yield. Note that the number of rows in which the plurality of output bumps 216 is arranged is not limited to 4 and may be 2, 3, 5 or more.

However, the formation of the input bumps 214 and the output bumps 216 in such an arrangement may cause the semiconductor element 210 to be tilted by the pressure applied to the semiconductor element 210 when the semiconductor element 210 is mounted over the substrate 102 as described below. This is because each row formed by the plurality of output bumps 216 is bent and because the plurality of output bumps 216 is asymmetrically arranged about an axis parallel to the longitudinal direction of the semiconductor element 210. Hence a plurality of dummy bumps 218 is provided to prevent contact failures of the semiconductor element 210 caused by the tilt of the semiconductor element 210. The dummy bumps 218 are disposed in the region created by the inclination of the plurality of rows formed by the output bumps 216 included in the second bump group 216-2 and the third bump group 216-3. Specifically, the plurality of dummy bumps 218 is provided on an opposite side of the input bumps 214 with respect to the second bump group 216-2, and similarly, the plurality of dummy bumps 218 is provided on an opposite side of the input bumps 214 with respect to the third bump group 216-3. The plurality of dummy bumps 218 is provided parallel to the direction in which the input bumps 214 are arranged, for example. Although not illustrated, the plurality of dummy bumps 218 may also be arranged over a plurality of rows or may take a staggered arrangement. In addition, the plurality of dummy bumps 218 may also be arranged on a bent or curved line. Unlike the input bumps 214 and the output bumps 216, the dummy bumps 218 are electrically insulated and independent from the circuit of the semiconductor element 210, are not electrically connected to the circuit and the pixels 120, and do not exert any electrical action on the display device 100.

### 4. Frame Region

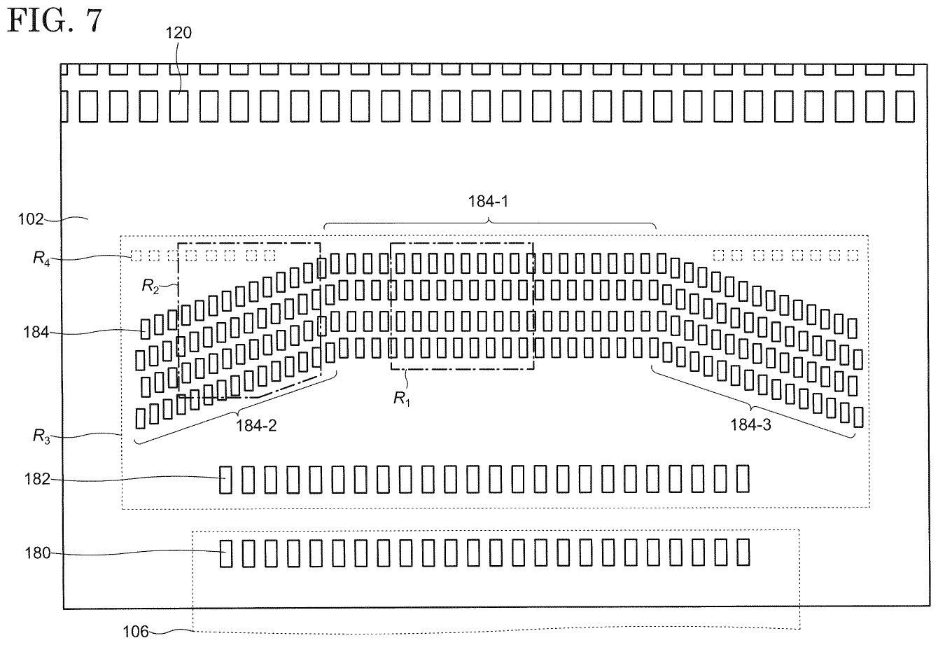

FIG. 7 shows a schematic top view of a portion of the frame region. This drawing shows the frame region where the semiconductor element 210 and the FPC 106 are arranged. As shown in FIG. 7, a plurality of terminals 180 including a patterned conductive film is provided over the substrate 102, and a plurality of input pads 182 and a plurality of output pads 184 are further provided at the positions respectively corresponding to the input bumps 214 and output bumps 216 of the semiconductor element 210.

The plurality of terminals 180 is electrically connected to the plurality of input pads 182, respectively, by wirings which are not illustrated and supplies the signals input from the external circuit via the FPC 106 to the semiconductor element 210. The plurality of input pads 182 is electrically connected to the plurality of input bumps 214 of the semiconductor element 210, respectively, and the plurality of output pads 184 is electrically connected to the plurality of output bumps 216 of the semiconductor element 210, respectively. Thus, the input pads 182 take the same arrangement as the input bumps 214, while the output pads 184 also take the same arrangement as the output bumps 216.

That is, the plurality of input pads 182 is arranged parallel to one side of the substrate 102 (the short side in the example shown in FIG. 1 which is closest to the plurality of terminals 180 and parallel to the arrangement direction of the terminals 180). In other words, the plurality of input pads 182 is arranged parallel to the longitudinal direction of the region in which the semiconductor element 210 is mounted (the region R₃ in FIG. 7). In contrast, the output pads 184 are staggered over a plurality of rows. Furthermore, the plurality of output pads 184 can be divided into three pad groups each containing two or more output pads 184. In one pad group (first pad group) 184-1, the plurality of output pads 184 is arranged in a plurality of rows (here, four rows) parallel to the longitudinal direction of the region R₃ and takes a staggered arrangement. On the other hand, although the plurality of output pads 184 included in the second pad group 184-2, which is one of the other pad groups, is also arranged over a plurality of rows and takes a staggered arrangement, the direction of each row is inclined from the side and the arrangement direction of the plurality of input pads 182. Similarly, although the plurality of output pads 184 included in the third pad group 184-3, which is the remaining one pad group, is also arranged over a plurality of rows and takes a staggered arrangement, the direction of each row is inclined from the side and the arrangement direction of the plurality of input pads 182. The first pad group 184-1 is sandwiched between the second pad group 184-2 and the third pad group 184-3. The plurality of output pads 184 included in the second pad group 184-2 and the third pad group 184-3 is arranged symmetrically with respect to the first pad group 184-1 and is arranged so that the distance to the aforementioned side of the substrate 102 or the plurality of input pads 182 decreases with increasing distance from the first pad group 184-1.

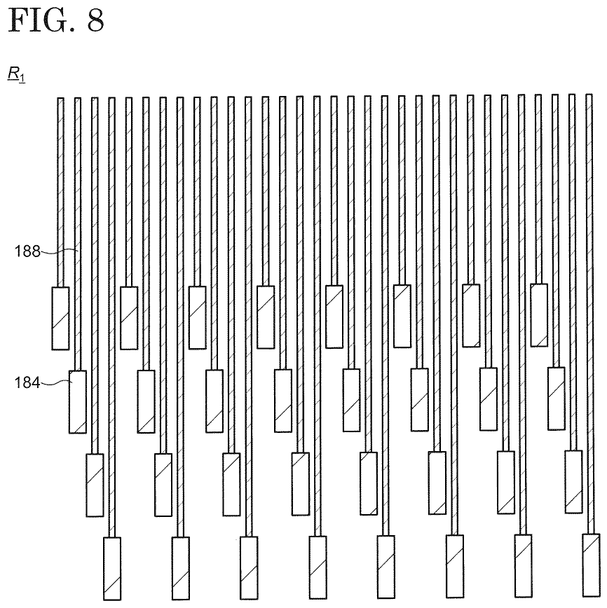

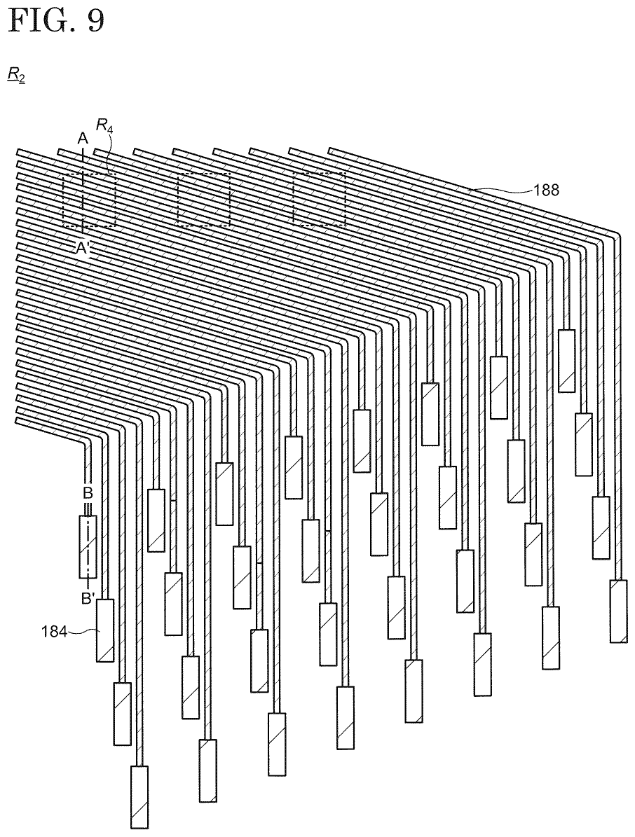

Enlarged views of the region R₁ and the region R₂ shown in FIG. 7 are schematically shown in FIG. 8 and FIG. 9, respectively. The region R₂ includes a region R₄ overlapping the dummy bumps 218 of the semiconductor element 210. As shown in FIG. 8, the lead wiring 188 is connected to each output pad 184. The lead wiring 188 is electrically connected to the signal line 124 or the detection wiring 202 extending in the display region. In the region R₁, the plurality of output pads 184 included in the first pad group 184-1 has a staggered-arrangement over a plurality of rows, and the direction of each row is parallel to the longitudinal direction of the region R₃ on which the semiconductor element 210 is mounted. Furthermore, the lead wiring 188 extends perpendicular to this longitudinal direction toward the display region.

As can be understood from FIG. 1, the width of the display region (length in the longitudinal direction of the semiconductor element 210) is larger than the length of the semiconductor element 210 in the longitudinal direction. Therefore, the direction of the row formed by the plurality of output pads 184 included in the second pad group 184-2 or the third pad group 184-3 is inclined from the arrangement direction of the plurality of input pads 182 as shown in FIG. 7. Moreover, at least a portion of the lead wiring 188 extending from the output pad 184 included in the second pad group 184-2 (or the third pad group 184-3) is bent, and at least a portion of the bent lead wiring 188 is arranged to extend in a direction inclined from a direction perpendicular to the arrangement direction of the plurality of input pads 182 as shown in FIG. 9, Such an arrangement allows the frame region to be efficiently used, resulting in an increase in the width/spacing (L/S) of the lead wiring 188. Accordingly, it is possible to prevent problems such as an increase in wiring resistance due to an inability to secure the width of the lead wiring 188 caused by variations during manufacturing and leakage due to an inability to secure the spacing of the lead wirings 188.

Here, as can be understood from FIG. 7 and FIG. 9, the lead wiring 188 is also arranged in the region R₄ where the dummy bump 218 of the semiconductor element 210 is provided. Therefore, the dummy bump 218 overlaps one or multiple lead wirings 188 in the frame region of the display device 100.

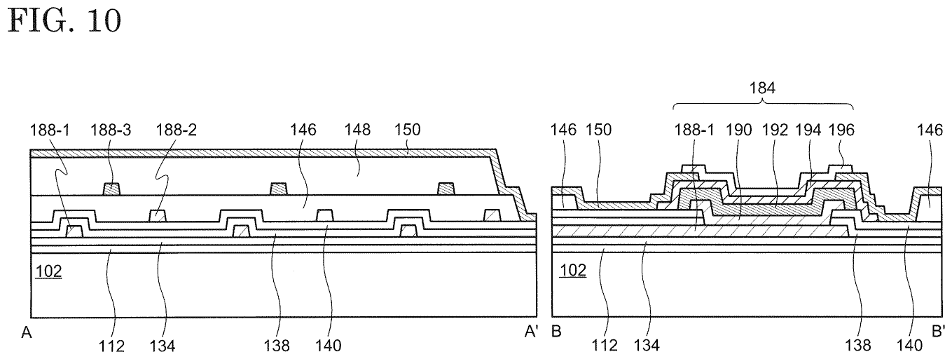

A schematic view of the cross sections along the chain lines A-A′ and B-B′ in FIG. 9 is shown in FIG. 10. As shown in the schematic view of the B-B′ cross section, the output pad 184 is configured to include a portion of a first wiring 188-1 structuring a portion of the lead wiring 188 as well as a first conductive film 190 over the first wiring 188-1, a second conductive film 192 over the first conductive film 190, a third conductive film 194 over the second conductive film 192, and a fourth conductive film 196 over the third conductive film 194. The first wiring 188-1 exists in the same layer as the gate electrode 136 of the switching transistor 130. Therefore, the first wiring 188-1 has the same thickness and composition as the gate electrode 136. The first wiring 188-1 is the lowest conductive film within the output pad 184 and extends over the gate insulating film 134 in the direction toward the display region. The first conductive film 190 is in physical and electrical contact with the first wiring 188-1 and exists in the same layer as the source electrode 142 and drain electrode 144 of the switching transistor 130. Therefore, the first conductive film 190 has the same thickness and composition as the source electrode 142 and drain electrode 144. The second conductive film 192 is in physical and electrical contact with the first conductive film 190 and exists in the same layer as the detection wiring 202. Therefore, the second conductive film 192 has the same thickness and composition as the detection wiring 202. The third conductive film 194 is in physical and electrical contact with the second conductive film 192 and exists in the same layer as the detection electrode 200. Therefore, the third conductive film 194 has the same thickness and composition as the detection electrode 200. The fourth conductive film 196 is in physical and electrical contact with the third conductive film 194 and exists in the same layer as the pixel electrode 162. Therefore, the fourth conductive film 196 has the same thickness and composition as the pixel electrode 162. As described above, the detection electrode 200 and the pixel electrode 162 are configured to include a conductive oxide. Hence, it is possible to prevent corrosion of the first wiring 188-1, the first conductive film 190, and the second conductive film 192 each including a metal, in the processes after forming the third conductive film 194 existing in the same layer as the detection electrode 200.

The first wiring 188-1 may be connected to a second wiring 188-2 (see the A-A′ cross section of FIG. 10) existing in the same layer as the source electrode 142 or the drain electrode 144 of the switching transistor 130 in the frame region through an opening (not illustrated) formed in the interlayer insulating film (the first interlayer insulating film 138 and the second interlayer insulating film 140). In this case, the first wiring 188-1 does not extend to the display region, and the signal supplied from the output pad 184 to the first wiring 188-1 is supplied to the display region via the second wiring 188-2. Similarly, the second wiring 188-2 may be connected to a third wiring 188-3 (see the A-A′ cross section of FIG. 10) existing in the same layer as the detection wiring 202 through an opening (not illustrated) formed in the first leveling film 146. In this case, the second wiring 188-2 does not also extend to the display region, and the signal supplied from the first wiring 188-1 to the second wiring 188-2 is supplied to the display region via the third wiring 188-3. In this manner, the plurality of lead wirings 188 is composed of the first wiring 188-1, the second wiring 188-2, and the third wiring 188-3 existing in different layers. Note that, although not illustrated, the first wiring 188-1 and the second wiring 188-2 may intersect with each other through the interlayer insulating film (the first interlayer insulating film 138 and the second interlayer insulating film 140). Furthermore, the second wiring 188-2 and the third wiring 188-3 may intersect with each other through the first leveling film 146. Similarly, the first wiring 188-1 and the third wiring 188-3 may intersect with each other through the interlayer insulating film (the first interlayer insulating film 138 and the second interlayer insulating film 140) and the first leveling film 146.

The first leveling film 146 also extends from the display region to the frame region and covers the plurality of lead wirings 188 existing in different layers (i.e., the first wiring 188-1 and the second wiring 188-2). Similarly, the second leveling film 148 also extends from the display region to the frame region and covers all of the lead wirings 188 existing in different layers (i.e., the first wiring 188-1, the second wiring 188-2, and the third wiring 188-3). The interelectrode insulating film 150 also extends from the display region to the frame region and is arranged to contact the top surface and the side surface of the second leveling film 148 and the side surface of the first leveling film 146 in the frame region. In the frame region, a portion of the first leveling film 146 may be exposed from the second leveling film 148. In this case, the interelectrode insulating film 150 may be in contact with the top surface of the first leveling film 146 exposed from the second leveling film 148. The second leveling film 148 may or may not be provided on the input pad 182 side from the output pad 184 (see B-B′ cross section in FIG. 10).

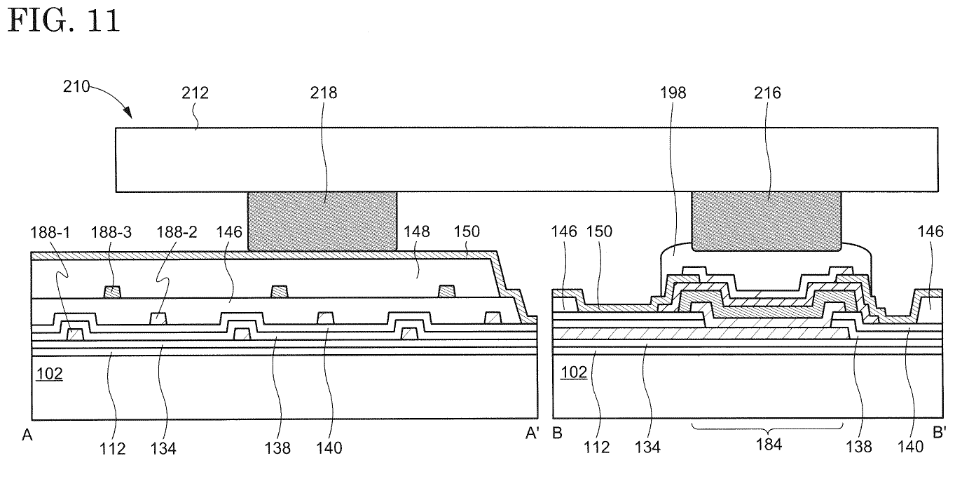

As shown in FIG. 11, the semiconductor element 210 is mounted over the substrate 102 by electrically connecting the output bumps 216 and the output pads 184 with an anisotropic conductive film 198. Although not illustrated, the input bumps 214 and the input pads 182 are also electrically connected to each other by the anisotropic conductive film 198. Specifically, the anisotropic conductive film 198 is placed over the input pads 182 and the output pads 184, and the semiconductor element 210 is placed thereover. At this time, the dummy bumps 218 may be in direct contact with the interelectrode insulating film 150 covering the first leveling film 146 and the second leveling film 148. In this state, the anisotropic conductive film 198 is heated while applying pressure to the semiconductor element 210 from above. Thereafter, cooling is performed so that a resin contained in the anisotropic conductive film 198 is solidified and the conductive particles contained in the anisotropic conductive film 198 form conductive paths. The input bumps 214 and the output bumps 216 are electrically connected to the input pads 182 and the output pads 184, respectively, by this process.

As described above, although the output bumps 216 are arranged on the bottom surface of semiconductor element 210 asymmetrically with respect to an axis parallel to the longitudinal direction of the semiconductor element 210, the dummy bumps 218 are also provided so that the semiconductor element 210 can be mounted over the substrate 102 without tilting. Furthermore, although the interelectrode insulating film 150 receives pressure from the dummy bumps 218 due to the pressurization, the lead wirings 188 located under the interelectrode insulating film 150 are protected by the first leveling film 146 and the second leveling film 148 formed with a polymer. Therefore, even if the dummy bumps 218 overlap the lead wirings 188 when the semiconductor element 210 is mounted, damage or disconnection of the lead wirings 188 can be prevented. These characteristics allow the frame region of the display device 100 to be effectively utilized compared with conventional display devices in which dummy pads are formed in the region R₄ and the lead wirings are arranged to avoid the dummy pads. Therefore, it is also possible to make the frame region smaller and provide a display device with superior designability. Furthermore, since the L/S of the lead wirings 188 can be increased, the defects caused by an increase in the density of the lead wirings 188 can be suppressed. This feature also contributes to improvement of the manufacturing yield and reduction of the manufacturing cost of the high-definition display device.

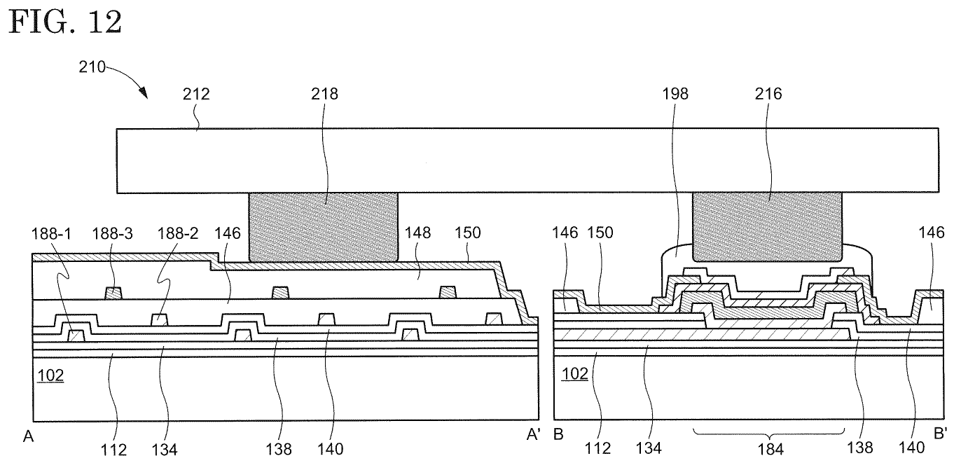

Note that excessive pressure may be applied to the interelectrode insulating film 150 when fixing the semiconductor element 210, depending on the heights of the output bumps 216 and dummy bumps 218. In this case, a part of the second leveling film 148 may be thinly formed as shown in FIG. 12. That is, the thickness of the second leveling film 148 in the region R₄ overlapping the dummy bump 218 of the semiconductor element 210 may be set to be smaller than that in the region which does not overlap the dummy bump 218. This configuration can prevent damage or disconnection of the lead wirings 188 caused by the excessive pressure.

The second leveling film 148 having regions of different thicknesses can be formed by performing exposure using a gray-tone mask or a halftone mask. For example, a positive-type resist providing the second leveling film 148 is coated over the substrate 102 on which the components up to the detection wiring 202 are formed, and then exposure is performed through a gray tone mask or a halftone mask. At this time, the gray tone mask or the halftone mask is positioned so that a slit provided to the gray tone mask and having a width less than the resolution of the exposure apparatus or a semi-transparent portion of the halftone mask overlaps the region R₄ where the dummy bumps 218 overlap. On the other hand, the gray tone mask or the halftone mask is placed so that light is not applied to the region which does not overlap the dummy bumps 218, but the light from the exposure apparatus is not blocked in the region where the second leveling film 148 is not provided. As a result, the region R₄ overlapping the dummy bump 218 becomes an intermediately exposed portion, the region which does not overlap the dummy bumps 218 becomes an unexposed portion, and the region which is not to be provided with the second leveling film 148 becomes an exposed portion. Subsequential development allows the thickness of the region R₄ overlapping the dummy bumps 218 to be smaller than the thickness of the region which does not overlap the dummy bumps 218. When a negative-type resist is used, the unexposed portion and the exposed portion may be interchanged.

Although the aforementioned embodiments were described using liquid crystal displays as display devices, the above embodiments described above can also be applied to electroluminescence display devices utilizing organic electroluminescence.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A display device comprising:
a substrate;
at least one pixel over the substrate;
at least one pad located over the substrate and configured to be electrically connected to a semiconductor element provided over a semiconductor substrate; and
a lead wiring electrically connecting the at least one pixel to the at least one pad,
wherein the at least one pixel comprises:
a transistor;
a leveling film over the transistor; and
a display element located over the leveling film and electrically connected to the transistor,
the semiconductor element comprises:
a circuit configured to drive the at least one pixel;
a bump electrically connected to the circuit; and
a dummy bump electrically independent from the circuit, and
the lead wiring is arranged to overlap the dummy bump through the leveling film when the bump is connected to the at least one pad.

2. The display device according to claim 1,
wherein the leveling film comprises a first leveling film and a second leveling film over the first leveling film.

3. The display device according to claim 1, further comprising an inorganic film covering the leveling film,
wherein the inorganic film is configured to be in contact with the dummy bump when the bump is connected to the at least one pad.

4. The display device according to claim 1,
wherein the transistor comprises:
a semiconductor film;
a gate electrode overlapping the semiconductor film;
a gate insulating film sandwiched by the gate electrode and the semiconductor film; and
a source electrode and a drain electrode electrically connected to the semiconductor film,
wherein at least a part of the lead wiring exists in the same layer as the gate electrode, the source electrode, or the drain electrode.

5. The display device according to claim 1, further comprising a detection electrode between the transistor and the display element,
wherein at least a part of the lead wiring exists in the same layer as the detection electrode.

6. The display device according to claim 2,
wherein a thickness of the second leveling film in a region overlapping the dummy bump when the bump is connected to the at least one pad is smaller than the thickness in a region which does not overlap the dummy bump.

7. The display device according to claim 1,
wherein the at least one pixel includes a plurality of pixels,
the at least one pad includes a plurality of pads each electronically connected to a corresponding pixel among the plurality of pixels, and
the plurality of pads is arranged in a plurality of rows.

8. The display device according to claim 7,
wherein the plurality of pads is staggered.

9. The display device according to claim 7,
wherein the plurality of pads is divided into a first pad group and a second pad group each including two or more pads,
the plurality of rows is parallel to a side of the substrate in the first pad group, and
the plurality of rows is inclined from the side in the second pad group.

10. The display device according to claim 9,
wherein, in the second pad group, a distance from the pad to the side decreases as a distance from the first pad group increases.

11. A display device comprising:
a substrate;
at least one pixel over the substrate;
at least one pad over the substrate;
a lead wiring electrically connecting the at least one pixel to the at least one pad; and
a semiconductor element electrically connected to the at least one pad and provided over a semiconductor substrate,
wherein the at least one pixel comprises:
a transistor;
a leveling film; and
a display element located over the leveling film and electrically connected to the transistor,
the semiconductor element comprises:
a circuit configured to drive the at least one pixel;
a bump electrically connected to the circuit; and
a dummy bump electrically independent from the circuit, and the lead wiring overlaps the dummy bump through the leveling film.

12. The display device according to claim 11,
wherein the leveling film has a first leveling film and a second leveling film over the first leveling film.

13. The display device according to claim 11, further comprising an inorganic film covering the leveling film,
wherein the inorganic film is in contact with the dummy bump.

14. The display device according to claim 11,
wherein the transistor comprises:
a semiconductor film;
a gate electrode over the semiconductor film;
a gate insulating film sandwiched by the semiconductor film and the gate electrode; and
a source electrode and a drain electrode electrically connected to the semiconductor film,
wherein the lead wiring exists in the same layer as the gate electrode, the source electrode, or the drain electrode.

15. The display device according to claim 11, further comprising a detection electrode between the transistor and the display element,
wherein the lead wiring exists in the same layer as the detection electrode.

16. The display device according to claim 12,
wherein a thickness of the second leveling film in a region overlapping the dummy bump is smaller than the thickness in a region which does not overlap the dummy bump.

17. The display device according to claim 11,
wherein the at least one pixel includes a plurality of pixels,
the at least one pad includes a plurality of pads each electrically connected to a corresponding pixel among the plurality of pixels, and
the plurality of pads is arranged in a plurality of rows.

18. The display device according to claim 17,
wherein the plurality of pads is staggered.

19. The display device according to claim 17,
wherein the plurality of pads is divided into a first pad group and a second pad group each including two or more pads,
the plurality of rows is parallel to a side of the substrate in the first pad group, and
the plurality of rows is inclined from the side in the second pad group.

20. The display device according to claim 19,
wherein, in the second pad group, a distance from the pad to the side decreases as a distance from the first pad group increases.
